(19) United States
(12) Patent Application Publication
(10) Pub. No.: US 2011/0150184 A1
(43) Pub. Date: Jun. 23, 2011

(54) MULTIPLE WAVELENGTH X-RAY SOURCE

(76) Inventors: Krzysztof Kozaczek, Midway, UT (US); Sterling Cornaby, Springville, UT (US); Steven Liddiard, Springville, UT (US); Charles Jensen, American Fork, UT (US)

(21) Appl. No.: 12/640,154

(22) Filed: Dec. 17, 2009

(51) Int. Cl. H01J 35/14

(52) U.S. Cl. 378/138

(57) ABSTRACT

A multiple wavelength x-ray source includes a multi-thickness target, having at least a first and a second thickness. The first thickness can substantially circumscribe the second thickness. An electron beam can be narrowed to impinge primarily upon second thickness or expanded to impinge primarily upon the first thickness while maintaining a constant direction of the beam. This invention allows the target thickness to be optimized for the desired output wavelength without the need to redirect or realign the x-rays towards the target.

### BACKGROUND

X-ray tubes can include an electron source, such as a filament, which can emit an electron beam into an evacuated chamber towards an anode target. The electron beam causes the anode target material to emit elemental-specific, characteristic x-rays and Bremsstrahlung x-rays. X-rays emitted from the anode target material can impinge upon a sample. The sample can then emit elemental-specific x-rays. These sample emitted x-rays can be received and analyzed. Because each material emits x-rays that are characteristic of the elements in the material, the elements in the sample material can be identified.

The characteristic x-rays emitted from both the target and the sample can include K-lines and L-lines for K and L electron orbital atomic transitions respectively. The K-lines of a given element are higher in energy than the L-lines for that element. For quantification of the amount of an element in the sample, it is important that a K-line or an L-line in the anode target have a higher energy than a K-line or an L-line in the sample. It is also desirable for the K-line or the L-line in the anode target to have an energy relatively close to the K-line or L-line in the sample, in order to maximize the K-line or L-line x-ray signal from the sample, thus improving the accuracy and precision of analysis.

If an L-line from the x-ray tube's anode target is higher than and close to the energy of a K-line or L-line in the sample, then the anode target L-line can be used for identification and quantification of the elements in the sample and it is desirable that the x-ray tube emit more of the target L-line x-rays and less K-line x-rays. The energy of the electrons impinging the target can be reduced by changing the x-ray tube voltage, thus causing the target to emit more L-line x-rays and less or no K-line x-rays. Thus the x-ray tube can emit relatively more L-line x-rays and less K-line and Bremsstrahlung x-rays. If the electron energy, controlled by the tube voltage, is lower than the energy of the K-line of the target, the K-line will not be emitted.

If a K-line from the x-ray tube's anode target is higher and close to the energy of a K-line or L-line in the sample, then the anode target K-line can be used for identification and quantification of the material in the sample and it is desirable that the x-ray tube emit more of the target K-line x-rays. The x-ray tube voltage can be increased in order to cause the x-ray tube to emit relatively more K-line x-rays. Thus it is desirable to adjust the x-ray tube voltage depending on the material that is being analyzed.

In a transmission x-ray tube, the use of a single anode target for multiple x-ray tube voltages can result in non-optimal use of the electron beam. A higher tube voltage can produce a higher energy electron beam. A higher energy electron beam can penetrate deeper into an anode target material. If the target material is too thin, then some of the electrons pass through the anode target material. Electrons that pass through the target anode material do not result in x-ray production by the target material and the overall efficiency of the electron to x-ray conversion is reduced. This is detrimental to the analysis of the sample since a higher rate of x-ray production can improve the precision and accuracy of analysis and reduces the time of measurement.

A lower tube voltage can produce a lower energy electron beam. A lower energy electron beam will not penetrate as deeply into the target material as will a higher energy beam. If the target material is too thick, then some of the x-rays produced will be absorbed by the target anode material. Target absorbed x-rays are not emitted towards the sample. This is another inefficient use of the electron beam.

Inefficient use of the electron beam to create the desired x-rays is undesirable because a longer sampling time is then required for material analysis than if all the electrons were used for production of target emitted x-rays. Thus if the target anode material is optimized for use at high x-ray tube voltages, then when used at low x-ray tube voltages, some of the target x-rays will be absorbed by the target material. If the target material is optimized for use at low x-ray tube voltages, then when used at high x-ray tube voltages, some of the electron beam will pass through the target material without production of x-rays.

If the target material target is compromised at an intermediate thickness, then at low tube voltage, some target produced x-rays will be reabsorbed by the target material, but not as many as if the target material was optimized for high tube voltage. Also, at high tube voltage, some of the electron beam will pass through the target, but not as much as if the target material was optimized for low tube voltage. Thus there is a problem at both high and low tube voltages.

Multiple targets may be used for production of different wavelengths of x-rays. For example, see U.S. Pat. Nos. 4,870,671; 4,007,375, and Japanese Patent Nos. JP 5-135722 and JP 4-171700. One target may be optimized for one tube voltage and another target may be optimized for a different tube voltage. A problem with multiple targets can be that the x-rays emitted from one target can be directed to a different location than x-rays emitted from a different target. This can create problems for the user who may then need to realign the x-ray tube or tube optics each time a transition is made from one target to another target.

The need to realign the x-ray tube or tube optics may be overcome by use of a layered target, with each layer comprised of a different material. For example, see U.S. Pat. No. 7,203,283. A problem with a layered target can be that an x-ray spectrum emitted from a layered target can contain energy lines originating from all target layers making the analysis more cumbersome and less precise.

X-rays emitted from multiple targets can be directed by optics towards the sample material. For example, see U.S. Patent Publication No. 2007/0165780 and WIPO Publication No. WO 2008/052002. Additional optics can have the disadvantage of increased complexity and cost.

### SUMMARY

It has been recognized that it would be advantageous to develop an x-ray source that optimally uses the electron beam when changing from one x-ray wavelength to another. It has also been recognized that it would be advantageous to develop an x-ray source that avoids the need to realign the x-ray tube or use optics to redirect the electron beam when changing from one x-ray wavelength to another.

The present invention is directed to a multiple wavelength x-ray source that satisfies the need for changing from one wavelength to another without x-ray tube alignment, without the need for additional optics to redirect the x-ray beam, and without loss of efficiency of the electron beam. The apparatus comprises an x-ray source comprising an evacuated tube, an anode coupled to the tube, and a cathode opposing the anode and also coupled to the tube. The anode includes a window with a target. The target has a material configured to produce X-rays in response to impact of electrons. The cathode includes an electron source configured to produce electrons which are accelerated towards the target in response to an electric field between the anode and the cathode, defining an electron beam. The target has an outer region substantially circumscribing an inner region. Either the inner or the outer region is thicker than the other region. The inner region is disposed substantially at the center of a desired path of the electron beam.

### BRIEF DESCRIPTION OF THE DRAWINGS

FIG. 1 is a schematic cross-sectional side view of a multiple wavelength x-ray source in accordance with an embodiment of the present invention;

FIG. 2 is a schematic cross-sectional side view of a multiple thickness target in accordance with an embodiment of the present invention;

FIG. 3 is a schematic cross-sectional side view of a multiple thickness target in accordance with an embodiment of the present invention;

FIG. 4 is a schematic cross-sectional side view of a multiple thickness target in accordance with an embodiment of the present invention;

FIG. 5 is a schematic top view of a multiple thickness target in accordance with an embodiment of the present invention;

FIG. 6 is a schematic cross-sectional side view of the multiple thickness target of FIG. 5 taken along line 6-6 in FIG. 5;

FIG. 7 is a schematic cross-sectional side view of a multiple thickness target in accordance with an embodiment of the present invention;

FIG. 8 is a schematic cross-sectional side view of a multiple thickness target in accordance with an embodiment of the present invention;

FIG. 9 is a schematic top view of a multiple thickness target in accordance with an embodiment of the present invention;

FIG. 10 is a schematic cross-sectional side view of the multiple thickness target of FIG. 9 taken along line 10-10 in FIG. 9;

FIG. 11 is a schematic top view of a cathode filament in accordance with an embodiment of the present invention;

FIG. 12 is a schematic top view of a cathode filament in accordance with an embodiment of the present invention;

FIG. 13 is a schematic top view of a cathode filament and a laser beam intensity profile in accordance with an embodiment of the present invention;

FIG. 14 is a schematic top view of a cathode filament and a laser beam intensity profile in accordance with an embodiment of the present invention;

FIG. 15 is a schematic cross-sectional side view of a multiple wavelength x-ray source in accordance with an embodiment of the present invention;

FIG. 16 is a schematic cross-sectional side view of a multiple wavelength x-ray source in accordance with an embodiment of the present invention;

FIG. 17 is a schematic cross-sectional side view of a multiple thickness target in accordance with an embodiment of the present invention;

FIG. 18 is a schematic cross-sectional side view of a multiple thickness target in accordance with an embodiment of the present invention;

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

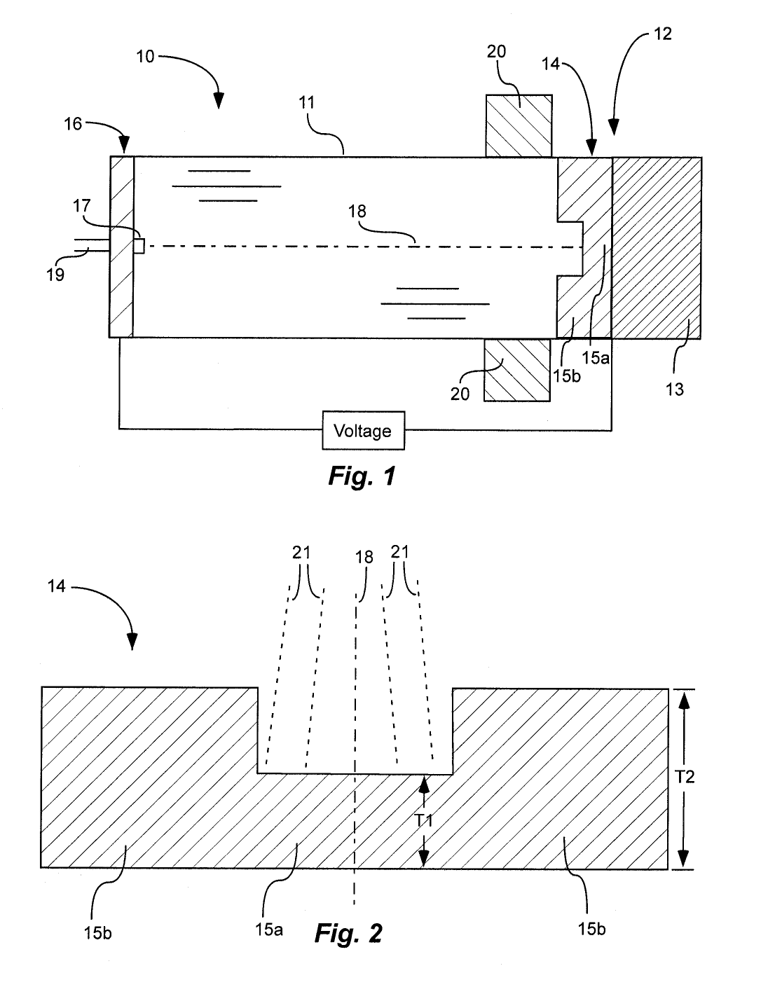

The multiple wavelength x-ray source 10, shown in FIG. 1 includes an evacuated tube 11, an anode 12 coupled to the tube, and a cathode 16, opposing the anode and also coupled to the tube 11. The anode 12 includes an x-ray transparent window 13 and a target 14. Although FIG. 1 shows the target 14 having a thickness that is similar to a thickness of the window 13, typically the window 13 is much thicker than the target 14. A relatively thicker target 14 is shown in order to aid in showing features of the target, such as an inner region 15a of the target and an outer region of the target 15b, wherein one region is thicker than the other region, defining a thicker region and a thinner region. The cathode 16 includes at least one electron source 17 which is configured to produce electrons accelerated towards the target 14, in response to an electric field between the anode 12 and the cathode 16, defining an electron beam. The electron source 17 can be a filament. The target 14 is comprised of a material configured to produce x-rays in response to impact of electrons. The multiple wavelength x-ray source 10 also includes a means for expanding and narrowing an electron beam while maintaining a center or direction 18 of the electron beam in substantially the same location.

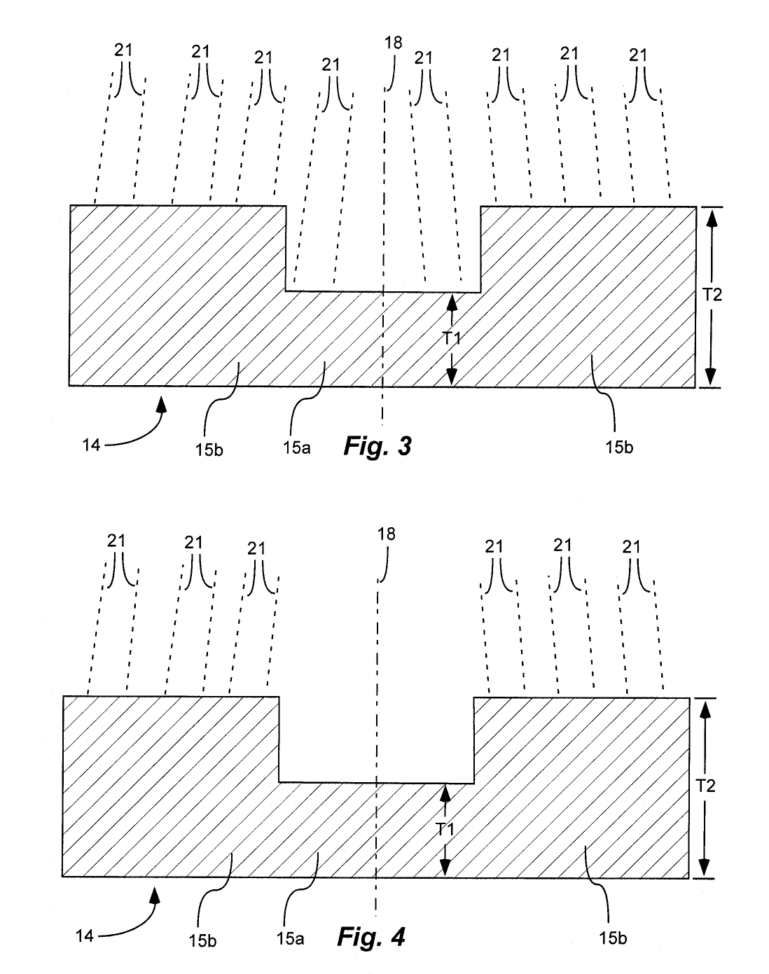

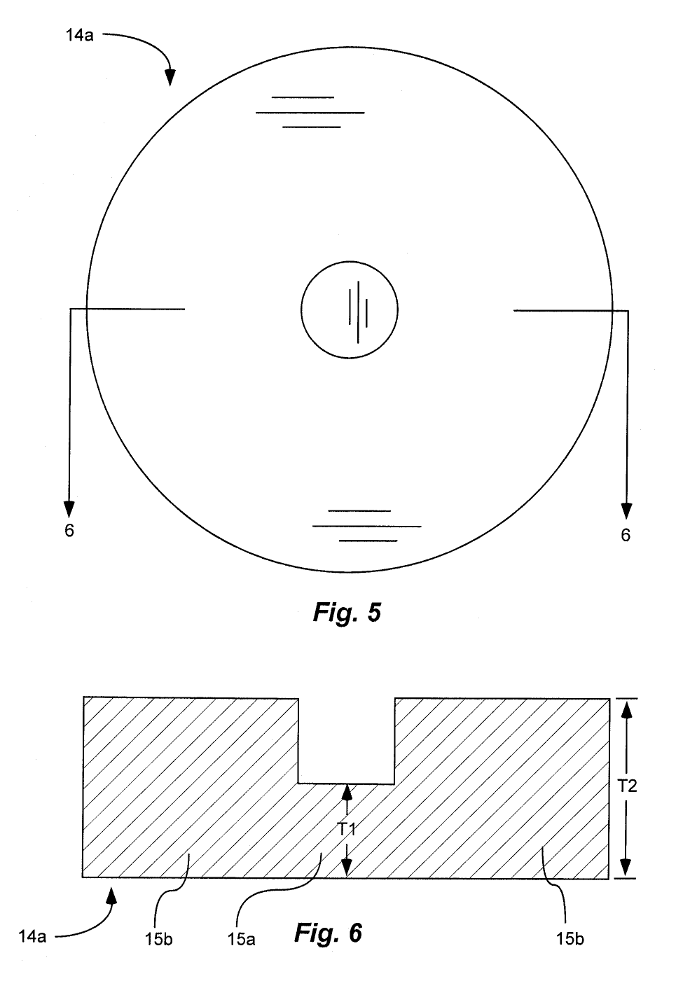

As shown in FIG. 2, an electron beam 21 can be narrowed in order to impinge mostly upon the inner region 15a of the target 14. As shown in FIG. 3, the electron beam 21 can be expanded in order to impinge upon substantially the entire target region. The area of the outer region can be significantly greater than the area of the inner region such that when the electron beam 21 is expanded to impinge upon the entire target region, only a small fraction of the electron beam 21 will actually impinge upon the inner region. As shown in FIG. 4, depending on the means selected for expanding the electron beam 21, the electron beam can be significantly stronger in the outer region or perimeter of the electron beam and significantly weaker in the central region of the electron beam such that only a very minimal portion of the electron beam will impinge on the inner region 15a of the target when the electron beam is expanded.

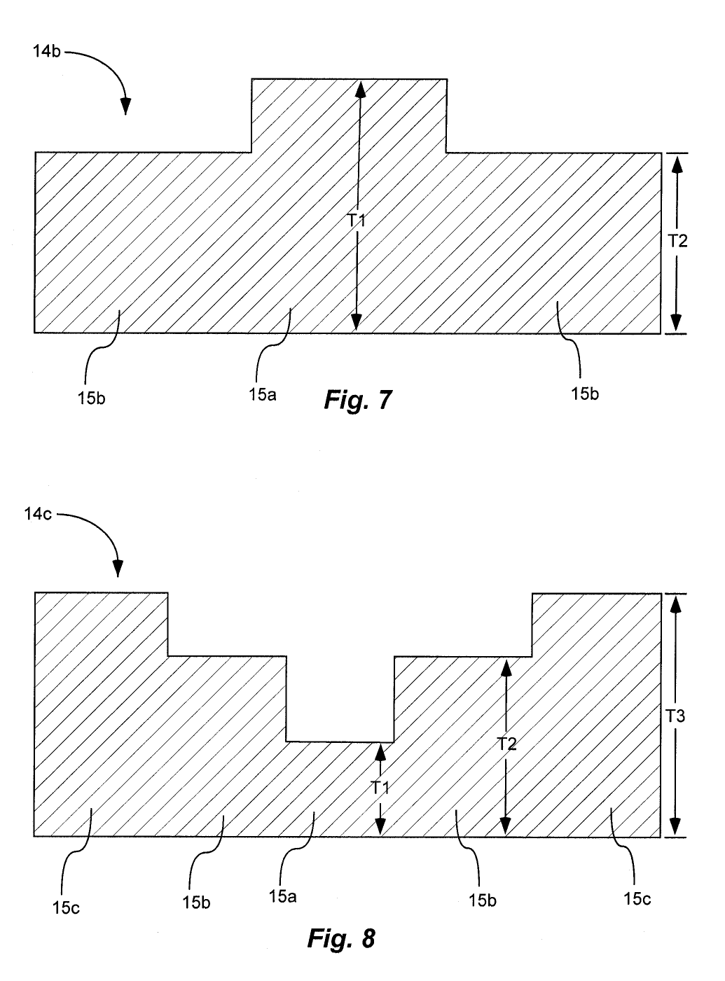

As shown in FIGS. 5 and 6, the outer region 15b can substantially circumscribe the inner region 15a. Although both the outer region and the inner region shown are circular in shape, the target can also be other shapes, such as oval, square, rectangular, triangle, polygonal, etc. The inner region can have a thickness T1 that is different from a thickness T2 of the outer region. As shown in FIG. 6, the inner region can be thinner and the outer region can be thicker. Alternatively, as shown in FIG. 7, the target 14b can have the inner region be thicker and the outer region be thinner. As shown in FIG. 8, a target 14c can have more than two thicknesses. Although the target 14c in FIG. 8 is thickest in the outermost region 15c, thinner in the next inner adjacent region 15b, and thinnest in the innermost region 15a, alternative arrangements of thicknesses may be utilized, such as having the thinner region as the outermost region 15c and the thickest region as the innermost region 15a. A target may include more than the three different thicknesses shown in FIG. 8. A target with more than two thicknesses can allow target thickness to be optimized at more than two tube voltages.

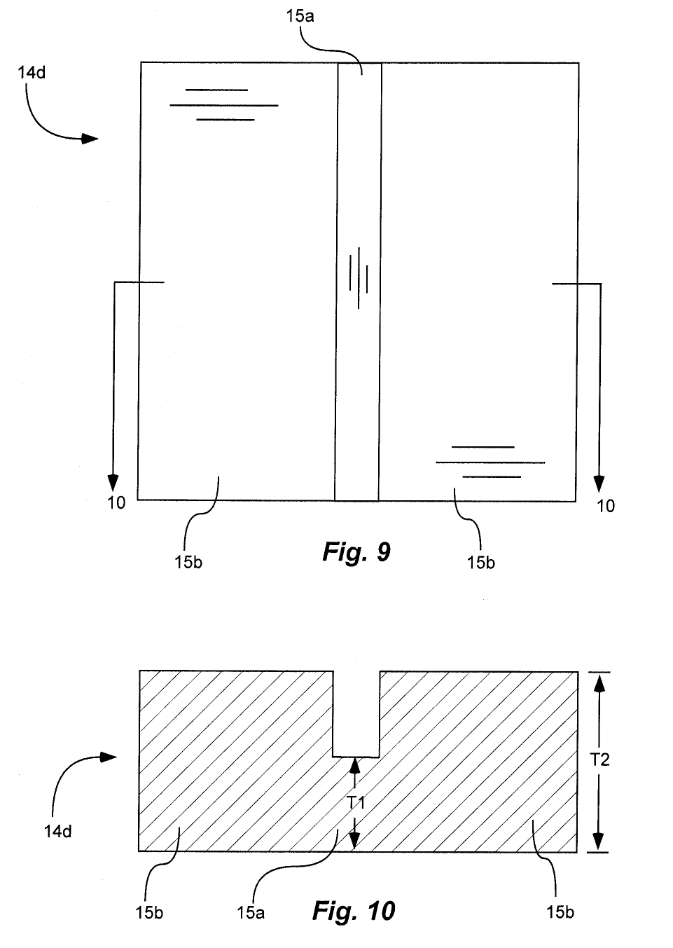

The inner region 15a of target 14d, shown in FIGS. 9 and 10 is in the shape of a channel. The thicker region 15b is disposed on both sides of the inner region 15a but does not necessarily circumscribe the inner region. The electron beam can be narrowed to impinge primarily on the inner region 15a and expanded to impinge mostly on the outer region 15b of the target. Although the inner region 15a of target 14d is thinner than the outer region 15b, the opposite configuration may be used in which the inner region 15a is thicker than the outer region 15b. Also, there could be more than two thicknesses of target material, as was described previously regarding target 14c. Target 14d may be beneficial if the region where the electron beam impinges on the target is more linear in shape rather than circular.

In the embodiments previously described, if the inner region 15a is thinner, then the electron beam can be narrowed to impinge primarily upon the inner region 15a when a lower voltage is applied between the anode 12 and the cathode 16. The thickness T1 of the inner region 15a of the target 14 can be optimized for this lower voltage. This can result in a strong L-line x-ray output. The electron beam can be expanded to impinge primarily upon the outer and thicker region 15b when a higher voltage is applied between the anode 12 and the cathode 16. The thickness T2 of the outer region 15b of the target 14 can be optimized for this higher voltage. This can result in a strong K-line x-ray output.

Alternatively, if the inner region 15a is thicker, then the electron beam can be narrowed to impinge primarily upon the inner region 15a when a higher voltage is applied between the anode 12 and the cathode 16. The thickness T1 of the inner region 15a of the target 14 can be optimized for this higher voltage. This can result in a strong K-line x-ray output. The electron beam can be expanded to impinge primarily upon the outer and thinner region 15b when a lower voltage is applied between the anode 12 and the cathode 16. The thickness T2 of the outer region 15b of the target 14 can be optimized for this lower voltage. This can result in a strong L-line x-ray output.

### Means for Expanding and Narrowing the Electron Beam

The means for expanding and narrowing the electron beam can be a magnet 20 as shown in FIG. 1. The magnet 20 can be a permanent magnet. The permanent magnet can cause the electron beam 21 to narrow when the permanent magnet is in close proximity to the anode. The electron beam 21 can expand when the permanent magnet is moved away from the anode.

The magnet 20 can be an electromagnet. The electromagnet can be annular and can surround the anode. For example, see U.S. Pat. No. 7,428,298 which is incorporated herein by reference. The electromagnet can include additional electron beam optics for further shaping the electron beam. The electrical current through the electromagnet can be adjusted, or turned on or off, to cause the electron beam to narrow or expand.

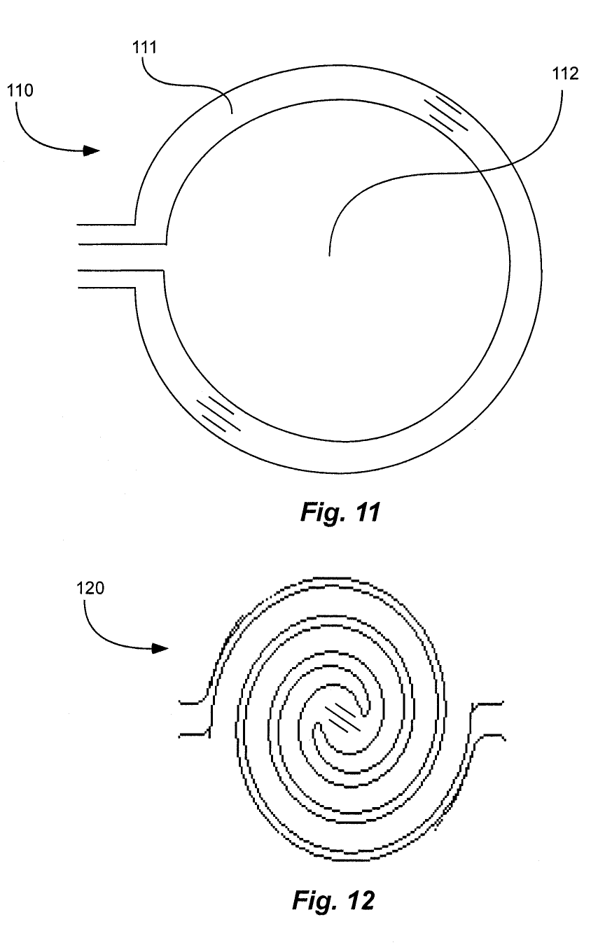

The means for expanding and narrowing the electron beam, and the electron source 17, can be at least one cathode filament. The filament can be resistively heated or laser heated. For example, both filaments 110 of FIG. 11 and filament 120 of FIG. 12 can be used. Filament 110 includes an outer region 111 and an empty inner region 112. Due to the shape of the filament 110, an electron beam emitted from this filament can impinge primarily on an outer portion of the target. Although filament 110 is circular in shape, this filament could be other shapes depending on the shape of the outer region 15b of the target 14. Filament 120 (of FIG. 12) can be placed in the empty inner region 112 of filament 110 (of FIG. 11). Filament 120 (FIG. 12) can emit an electron beam that is narrow and stronger in the center.

For example, if target 14a of FIGS. 5 and 6 is used with filaments 110 and 120 (FIGS. 11 and 12), an electrical current can be passed through filament 120 when a lower voltage is applied between the cathode 15 and the anode 12, thus causing a narrow electron beam to impinge primarily on the inner, thinner portion 15a of the target 14a. An electrical current can be passed through filament 110 when a higher voltage is applied between the cathode 15 and the anode 12, thus causing a wider electron beam to impinge primarily on the outer, thicker portion 15b of the target 14a.

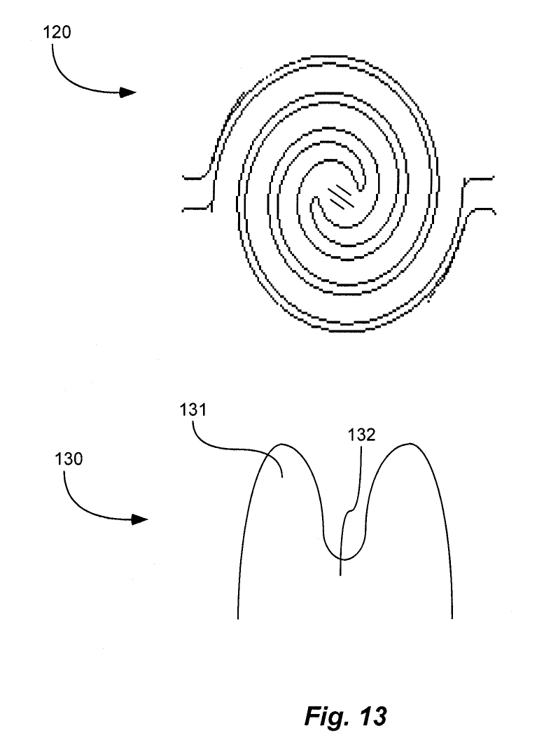

A laser 19, shown in FIG. 1, can be used to selectively heat sections of a filament, such that the emitted electron beam can be more intense in the center or on the edges, corresponding to the desired section of the target. The laser 19 in FIG. 1 is an optional addition to the embodiment shown in FIG. 1. The electron source 17 in FIG. 1 can be a filament which may be resistively heated rather than laser heated. Laser heated cathodes are described in U.S. Pat. No. 7,236,568, which is incorporated herein by reference. The filament can be a planar filament. Planar filaments are described in U.S. patent application Ser. No. 12/407,457, which is incorporated herein by reference. For example, filament 120 is shown in FIG. 13 along with a cross sectional laser beam intensity profile 130. The laser beam profile 130 is most intense at an outer perimeter 131 of the laser beam and less intense at a center of the laser beam 132. This can result in a more intense laser beam heating the outer perimeter of the filament, causing an electron beam profile to be emitted from the filament 120 that is similar in shape to the laser beam profile—stronger at an outer perimeter and less intense at the center, thus the electron beam would impinge primarily upon outer region 15b of the target and less upon the center 15a of the target.

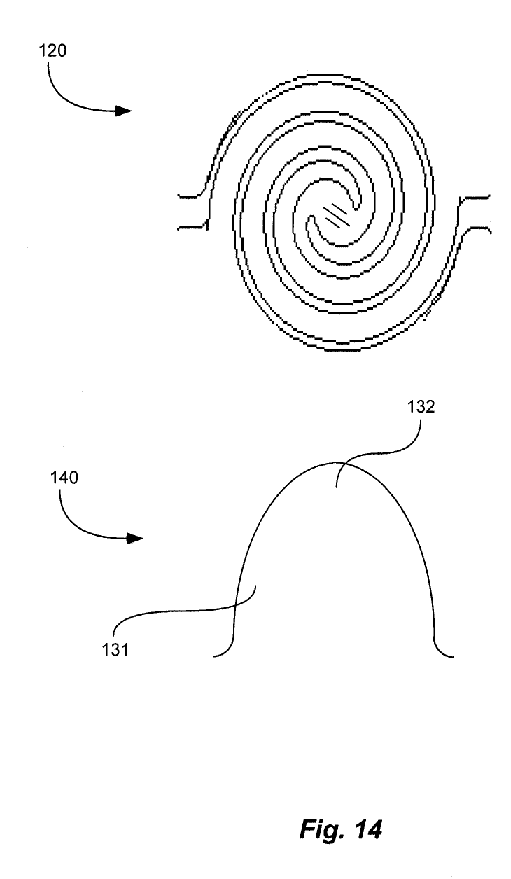

By changing the laser beam to a different transverse electromagnetic mode, such as TEM00, the laser beam can be more intense in the center 132 and less intense at the outer perimeter 131 as shown in laser beam intensity profile 140 of FIG. 14. This can result in a more intense laser beam heating the inner region of the filament 120, causing an electron beam profile to be emitted from the filament 120 that is similar in shape to the laser beam profile—stronger at the center and less intense at the outer perimeter, thus the electron beam would impinge primarily upon an inner region 15a of the anode target and less upon the outer region 15b of the anode target.

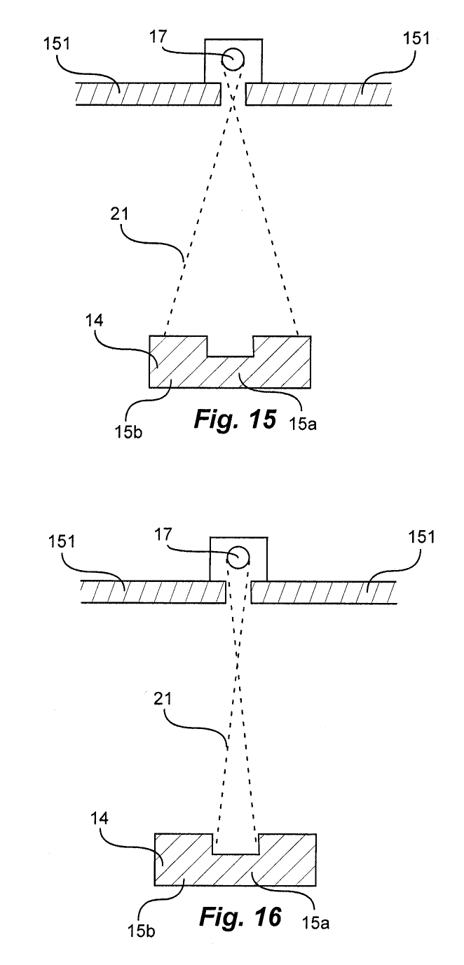

The means for expanding and narrowing the electron beam can be electron beam optics combined with changes in tube voltage. The electron beam optics can be designed so that the electron beam will be narrow when a lower voltage is applied across the tube and the electron beam expands when a higher voltage is applied across the tube. Alternatively, the electron beam optics can be designed so that the electron beam will be narrow when a higher voltage is applied across the tube and the electron beam expands when a lower voltage is applied across the tube. For example, shown in FIGS. 15 and 16, cathode optics 151 can cause the electron beam 21 to be narrow upon application of one voltage applied between the anode 12 and the cathode 16 and to expand upon application of a different voltage applied between the anode 12 and the cathode 16.

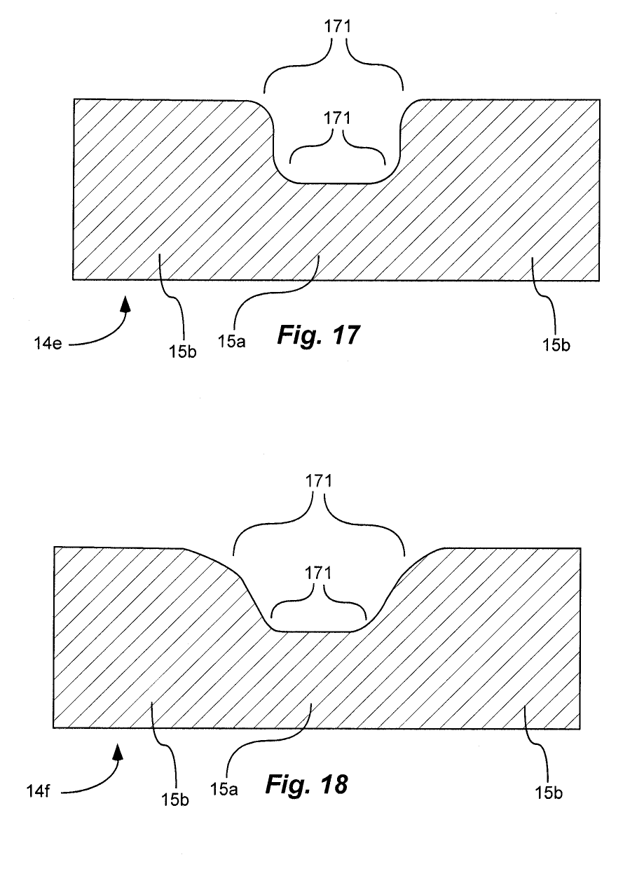

The targets shown previously have abrupt changes between the thicker and thinner regions. Targets 14e and 14f, shown in FIGS. 17 and 18, have gradual transitions 171 between the thicker and thinner regions. All invention embodiments can have either abrupt or gradual transitions in target thickness.

### How to Make

A standard target for an x-ray tube may be patterned and etched to create at least one thinner region. The target can be made of standard x-ray tube target materials, such as rhodium, tungsten, molybdenum, gold, silver, or copper, that can emit x-rays in response to an impinging electron beam. The target material can be selected such that the L and/or K lines of the target have a higher energy, and relatively close in energy, to a K-line or an L-line in the sample. The target can be made of a single material.

Various target shaped regions, with abrupt or gradual changes in thickness can be created by various patterning and isotropic etch and anisotropic etch procedures. U.S. patent application Ser. No. 12/603,242 describes creating various shaped cavities by various patterning and etch procedures. Such procedures may be applicable in creating various shaped targets. U.S. patent application Ser. No. 12/603,242 is incorporated herein by reference.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An x-ray source device, comprising:
a) an evacuated tube;
b) an anode coupled to the tube and including a window and a target;
c) the target having a material configured to produce x-rays in response to impact of electrons;
d) a cathode coupled to the tube opposing the anode and including at least one electron source configured to produce electrons accelerated towards the target in response to an electric field between the anode and the cathode, defining an electron beam;
e) the target having an outer region and an inner region, with one of the regions being thicker than the other region defining a thicker region and a thinner region; and
f) means for expanding and narrowing the electron beam while maintaining a center of the electron beam in substantially the same location.

2. A device as in claim 1, wherein:
a) the thicker region of the target is the outer region and the thinner region of the target is the inner region; and
b) the means for expanding and narrowing the electron beam:
i) narrows the electron beam to impinge mostly upon the thinner and inner region of the target when a lower voltage is applied across the cathode and the anode; and
ii) expands the electron beam to impinge upon the thicker and outer region of the target when a higher voltage is applied across the cathode and the anode.

3. A device as in claim 1, wherein:
a) the thinner region of the target is the outer region and the thicker region of the target is the inner region; and
b) the means for expanding and narrowing the electron beam:
i) narrows the electron beam to impinge mostly upon the thicker and inner region of the target when a higher voltage is applied across the cathode and the anode; and
ii) expands the electron beam to impinge upon the thinner and outer region of the target when a lower voltage is applied across the cathode and the anode.

4. A device as in claim 1, wherein the target comprises a single material.

5. A device as in claim 1, wherein the means for expanding and narrowing the electron beam comprises:
a) a first filament adapted for projecting an electron beam that is stronger on an outer perimeter of the beam than at a center of the beam; and
b) a second filament adapted for projecting an electron beam that is stronger in a center of the beam than at an outer perimeter of the beam.

5. A device as in claim 4, wherein the first filament and the second filament are planar filaments.

6. A device as in claim 1, wherein the means for expanding and narrowing the electron beam comprises electron beam optics.

7. A device as in claim 1, wherein the means for expanding and narrowing the electron beam comprises:
a) at least one electromagnet, associated with the tube, and adapted for affecting the electron beam;
b) the at least one electromagnet causing the electron beam to narrow in response to an increased electrical current through the at least one electromagnet; and
c) the at least one electromagnet causing the electron beam to expand in response to a decreased electrical current through the at least one electromagnet.

8. A device as in claim 1, wherein the means for expanding and narrowing the electron beam comprises at least one permanent magnet movable with respect to the evacuated tube to cause the electron beam to narrow and expand based on proximity of the magnet to the electron beam.

9. A device as in claim 1, wherein the means for directing the electron beam comprises:
a) a planar filament;
b) at least one laser adapted for heating the planar filament in order to cause the planar filament to emit electrons;
c) the at least one laser being adapted to direct a laser beam towards the filament that is stronger in a center of the laser beam than at a perimeter of the laser beam to form a narrower electron beam; and
d) the at least one laser being adapted to direct another laser beam towards the filament that is weaker in a center of the laser beam than at the perimeter of the laser beam to form an electron beam that is stronger at an outer perimeter of the electron beam than at a center of the electron beam.

10. An x-ray source device, comprising:
a) an evacuated tube;
b) an anode coupled to the tube and including a window and a target;
c) the target having a material configured to produce x-rays in response to impact of electrons;
d) a cathode coupled to the tube opposing the anode and including at least one electron source configured to produce electrons accelerated towards the target in response to an electric field between the anode and the cathode, defining an electron beam; and
e) the target having an outer region and an inner region, with one of the inner or outer regions being thicker than the other of the inner or outer regions defining a thicker region and a thinner region; and the inner region is disposed substantially at the center of a desired path of the electron beam.

11. A method of producing multiple wavelengths of x-rays from a single target, using the x-ray source device of claim 10, the method comprising:
a) narrowing the electron beam to mostly impinge upon the inner region for producing one x-ray wavelength; and
b) expanding the electron beam to impinge upon the outer region for producing a different x-ray wavelength.

12. A device as in claim 10, wherein the at least one electron source further comprises:
a) a first planar filament adapted for projecting an electron beam that is stronger on an outer perimeter of the beam than at a center of the beam such that a majority of the electron beam impinges on the outer region of the target; and
b) a second planar filament adapted for projecting an electron beam that is stronger in the center of the beam than at the outer perimeter of the beam such that a majority of the electron beam impinges on the inner region of the target.

13. A device as in claim 12, wherein:
a) the inner region of the target is the thinner region and the outer region of the target is the thicker region;
b) the first planar filament projects the electron beam mostly to the outer and thicker region of the target when a higher voltage is applied between the cathode and the anode; and
c) the second planar filament projects the electron beam mostly to the inner and thinner region of the target when a lower voltage is applied between the cathode and the anode.

14. A device as in claim 10, further comprising at least one additional outermost target region that is disposed outside of an outer perimeter of the outer region and has a thickness that is different from both the thicker region and the thinner region.

15. A device as in claim 10, wherein:
a) the inner region of the target is the thinner region and the outer region of the target is the thicker region;
b) the device further comprises:
i) electron beam optics to expand the electron beam wider when a higher voltage is applied between the cathode and the anode than when a lower voltage is applied between the cathode and the anode such that a majority of the electron beam impinges on the outer and thicker region of the target; and
ii) electron beam optics to narrow the electron beam when a lower voltage is applied between the cathode and the anode than when a higher voltage is applied the cathode and the anode such that a majority of the electron beam impinges on the inner and thinner region of the target.

16. A device as in claim 10, further comprising at least one electromagnet causing the electron beam to narrow in response to an increased electrical current through the at least one electromagnet and causing the electron beam to expand in response to a decreased electrical current through the at least one electromagnet.

17. A device as in claim 10, wherein the outer region of the target substantially circumscribes the inner region of the target.

18. A device as in claim 10, further comprising:
a) a planar filament;
b) at least one laser adapted for heating the planar filament in order to cause the planar filament to emit an electron beam;
c) the at least one laser being adapted to direct a laser beam towards the filament that is stronger in a center of the laser beam than at a perimeter of the laser beam to form a narrower electron beam; and
d) the at least one laser being adapted to direct another laser beam towards the filament that is weaker in a center of the laser beam than at the perimeter of the laser beam to form an electron beam that is stronger at an outer perimeter of the electron beam than at a center of the electron beam.

19. A method of producing multiple wavelengths of x-rays from a single target, the method comprising:
a) narrowing an electron beam to impinge primarily upon a central portion of the target for producing mostly x-rays of a first wavelength; and
b) expanding the electron beam to impinge primarily upon an outer portion of the target for producing mostly x-rays of a second wavelength.

20. A method as in claim 19, wherein the target has an outer region circumscribing an inner region; and wherein the outer region has a different thickness than the inner region.
